(19) United States
(12) Patent Application Publication
(10) Pub. No.: US 2006/0291481 A1
(43) Pub. Date: Dec. 28, 2006

(54) Application session resumption in mobile environments

(75) Inventor: Brijesh Kumar, Princeton Junction, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/167,460

(22) Filed: Jun. 27, 2005

(51) Int. Cl. H04J 3/22; H04J 3/16; H04L 12/56; H04L 12/28; H04Q 7/24

(52) U.S. Cl. 370/400; 370/465

(57) ABSTRACT

A session management system is provided for resumption of a previously interrupted session between an application client and an application server. The session management system includes: an application client and a session control agent residing on a mobile network device; and a session manager residing on a router of a home network associated with the mobile network device, such that messages to and from the mobile network device pass through the router. The session manager is able to intercept application information being exchanged between the application client and the application server and store a session state based upon the intercepted application information. The session control agent can subsequently interface with the session manager to restore the session state between the application client and the application server.

### FIELD OF THE INVENTION

The present invention relates to seamless mobility support in data networks, and more particularly, to maintaining or continuing sessions for applications after connectivity disruptions or an application session is moved from one device to another device (e.g., from a cellular phone to a PDA).

### BACKGROUND OF THE INVENTION

In IP-based data networks, each device is identified by a unique IP address. Every time a device moves from one sub-network to another, it loses its identity (i.e., its IP address) because IP addresses simply do not work outside the specific networks they belong to. Mobile IP protocol, as fully specified in Internet RFC 2288, describes a method of assigning new IP addresses as a device moves and related procedures for forwarding data to the mobile device.

Mobile IP protocol essentially provides network layer mobility, i.e., the ability of a device to move from one network location to another by adding two new components to the IP network. These two new components are known as a foreign agent (FA) and a home agent (HA). Each sub-network is required to have one or more foreign agents that broadcast their presence to mobile devices. A mobile node (MN) registers with a foreign agent, and requests a new “care-of” address as it moves from one IP sub-network to another. The home agent working in coordination with foreign agents keeps track of the current location of a mobile device and tunnels the packets from the home agent to the foreign agent at a current location. As long as the device, quickly moves from one coverage area to another before various protocol timers expires, this will ensure that sessions don't drop out. However, such continuity of network coverage is not always possible and thus may result in application session disruptions.

Moreover, a Layer 3 solution dealing with network mobility has no idea of application sessions, transaction threads, contents, device contexts, or any other application contexts. Mobile device users run applications, and it is the application continuity that matters to users. Since a Layer 3 mobility can only address point of attachment issues, it cannot guarantee application continuity since a mobile router has no idea what end applications were being run by a user when its last session got interrupted.

Network mobility is only one form of mobility intended to support continuity of the session between a mobile device and its counterpart. Some time, such as in personal area networks (PANs), even the device itself may need to be replaced while desiring the application session continuity between two communicating peers. For example, a user may begin an application session on a cellular phone or a PDA, but may like to transfer the application session to a Laptop computer. This change can be result of a user preference or may be necessitated by change in the user's communication circumstances. For example, a user may move from a wireless LAN in a home to a GPRS network or to an Ethernet network in the workplace. Each device may support interfaces for only a certain network.

Session Initiation Protocol (SIP) can provide application level mobility support for those applications that use SIP signaling. SIP, described in RFC 3261, is a well-known session management protocol, developed by IETF primarily for VoIP signaling. It is designed to provide signaling and session control for multi-media applications. SIP has ability to restore multi-media session, and hence can support terminal and session mobility using its capability to renegotiate a voice session from a different location or from a different device.

However, SIP mobility support is limited only to SIP sessions and applications that use SIP for their session management. A large number of applications use either a client server model utilizing HTTP or a proprietary transaction mechanism.

Therefore, it is desirable to provide session mobility for an application which relies upon HTTP or some other application specific client server transaction model. In particular, a seamless technique is needed for maintaining and resuming sessions after session continuity has been interrupted.

### SUMMARY OF THE INVENTION

In accordance with one aspect of the present invention, a session management system is provided for maintaining a session state with an application server. The session management system includes: an application client and a session control agent residing on a mobile network device; and a session manager residing on a router of a home network associated with the mobile network device, such that messages to and from the mobile network device pass through the router. The session manager is able to intercept application information being exchanged between the application client and the application server and store a session state based upon the intercepted application information. The session control agent can subsequently interface with the session manager to restore the session state between the application client and the application server.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a diagram of an exemplary home network environment;

FIG. 2 is a diagram of a session management system for maintaining a session state according to the principles of the present invention; and

FIG. 3 is diagram of an exemplary session management protocol for restoring a session in accordance with the present invention.

### DETAILED DESCRIPTION OF THE PREFERRED EMBODIMENTS

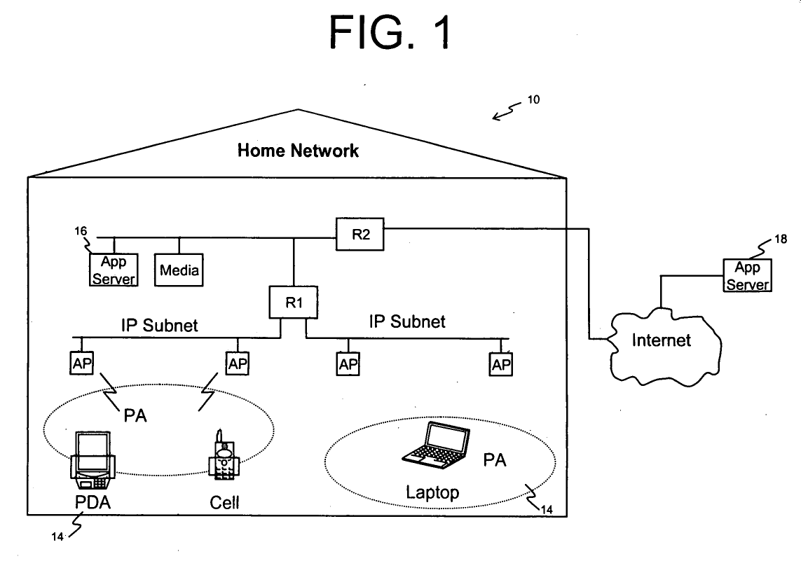

FIG. 1 is a diagram of an exemplary home network environment 10. In the home network, two IP sub-networks are connected to a home gateway R1. Each sub-network has multiple access points AP that provide wired or wireless links to various mobile network devices 14, such as a cellular phone, a PDA or a laptop computer. Each device may have its own operating characteristics in terms of application tools, screen size, processing capability and available memory. While the following description is provided with reference to a home network, it is readily understood that the present invention is more generally applicable to other types of local area networks.

The mobile network devices may host applications which are configured to interface with application servers. In some instances, a client application interfaces with an application server 16 residing within the home network. In other instances, the client application may interface via a network routing device R2 with an application server 18 residing outside of the home network environment.

A session is a sequence of service requests by a single user using a single client application to access a server. The information maintained in the session across requests is called a session state. Session states may include both information visible to the user (e.g., shopping cart contents) as well as application control information (such as user preferences) which is not apparent to the user. To maintain session persistence, the session state must be maintained at either the client device or the server device. In many instances, session states are only maintained on the client side.

When a client device moves from one location to another, it is possible that a pending session is interrupted. If the client device does not re-connect within a certain time, there is a possibility that the server may timeout, and closes the session. To avoid a client's session state from becoming stale, a mechanism is needed to ensure that the client's session states are refreshed when a mobile device is temporarily disconnected from the network. Similarly, if the client device is powered down or otherwise loses power, the client's session states are also lost. Each of these occurrences is likely when session states are maintained only on at the client device.

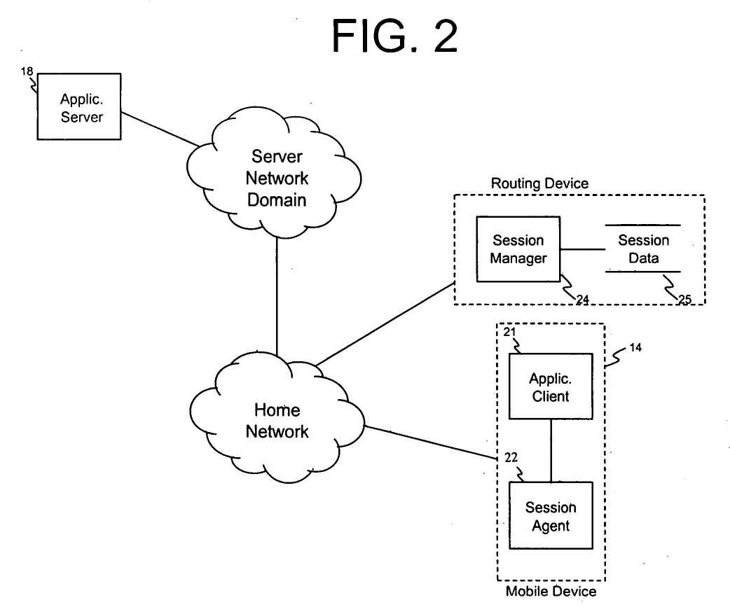

A session management system for maintaining a session state according to the principles of the present invention is shown in FIG. 2. The session management system is generally comprised of an application client 21, a session control agent 22 and a session manager 24. The application client 21 and session control agent 22 reside on a mobile network device 14 which may be operably connected to a home network. The session manager 24 resides on a router or other type of network routing device associated with the home network, such that messages to and from the network devices connected to the home network pass through the router.

In the context of the Mobile IP protocol, the session manager 24 may be integrated with either the foreign agent or the home agent. Since all communication to a mobile network device must be tunneled through these agents, the session manager can intercept all of the application information being transferred from an application server to the application client. Likewise, communication from the mobile network device to the application server must also be tunneled through these agents. This alternative arrangement ensures that all communication between the server and client is intercepted by the session manager.

In operation, the application client 21 is configured to interface with an application server 18 residing at a network domain outside of the home network. In an exemplary embodiment, the client is a Web Browser and the application server is a Web server, such that messages are exchanged using HTTP. It is readily understood that other types of stateless communication protocols are also within the scope of the present invention.

Messages exchanged between the application client 21 and application server 18 are intercepted by the session manager 24. Application information embodied in the messages is then extracted and stored in a data store 25 as a session state. In order to associate a stored session state with an applicable user, the session manager 24 is further operable to capture a network access identifier for the user of the mobile network device. A user's identity i.e., its network access identifier, can consist of a user's network login name or some other unique network identity. In corporate or cellular network, such an identity is typically assigned by a network system administrator at the initial provisioning of services to a user.

To enable session mobility, a session state is comprised of four types of session data: session context data, service context data, application context data and device context data. Each of these data types are further described below.

Session context data is used for keeping track of the current session state so that interrupted sessions can be check-pointed. A number of session parameters, such as TCP files transfer states (i.e., last byte received, acknowledged, etc.), application timer information, configured linger time (transaction refresh time) etc. are maintained by the session manager. This context essentially provides the session manager the ability to refresh a session with an application server when a session is interrupted.

Service context data is used for keeping track of the current state of the session with regards to security privileges and QoS parameters provided to a mobile user at this location. A number of service parameters, such as authentication state, current QoS levels, access control policies, device roaming policies, device session bandwidth limitations etc., are maintained by the session manager. This context is used to re-establish session from a new device location or with a new device having the same privileges as a previously interrupted session.

Application context data is context information regarding the application and its current state. Application context data is application specific, but may include a unique identifier for the last application used, last web page visited (URL), last transaction submitted (URI/ post data), application state information (i.e., cookie for http, proprietary data for other applications), and a cached copy of server response. In the context of HTTP, the application context data is comprised of the URL and cookie information that will allow a web browser to present this information to the server. Thus, the application context data enables the session manager to transparently maintain all application states of an application client in its local database. This allows a session manager to transfer this state to a new device when a user wants to change a device or user comes back after powering down a device that cannot maintain its application states locally in a non-volatile memory.

Device context data is used to map the application context to device type. For example, a mobile user may start an application on a cellular phone and then wishes to continue it on a laptop. Since a laptop can deal with much larger data and has significantly larger screen and other related capabilities, the session manager can ensure that the contents are appropriately transformed to suit the change in device and other device capabilities. A number of device specific parameters such as mobile device type and its characteristics, memory size, screen size, display tool, browser type, encryption ability etc. are maintained in the device context. A session manager learns the device capabilities and other device context information via its interaction with the session agent resident on a device.

Session mobility from one device to another relies on the ability of the session client on a new device to learn its application and session contexts from the session manager. When a mobile user reconnects with the network after a session disruption, the session agent on the device interacts with the session manager on the network router. This occurs after the device has done the necessary IP level configurations to be able to connect to the network. These steps may involve authentication with the wireless infrastructure, acquisition of new IP address, and binding of current IP address to permanently assigned home address using Mobile IP protocol. These network steps need to be completed before an application session can be restored on a new device.

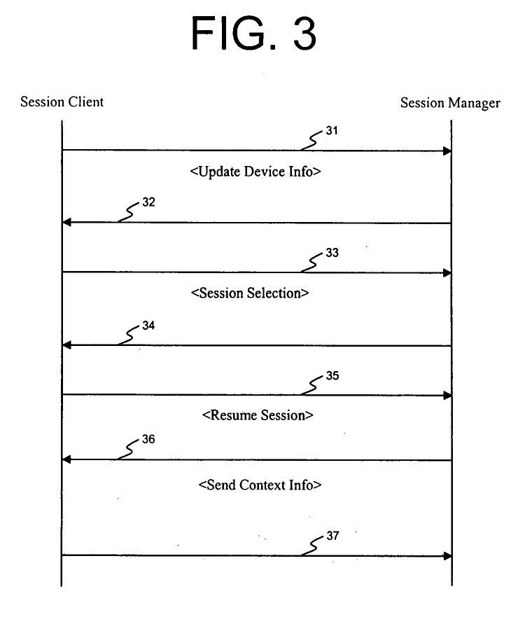

To initiate the recovery of previously interrupted application sessions, the session agent initiates a series of transactions with the session manager. An exemplary session management protocol for restoring a session is further described below in relation to FIG. 3. While an exemplary protocol is described below, it is readily understood that variations in the protocol are well within the broader aspects of the present invention.

First, the session agent generates an update device information message as indicated at 31. This message is sent by the session agent to the session manager to initiate the recovery process. This message informs the session manager about the users unique network access identity, device type and device capabilities. In an exemplary embodiment, this information is encoded in an XML message, but can also be encoded in other formats.

Upon receipt of the update device information message, the session manager returns an acknowledgement message 32 to the session agent. This message also serves to inform the session agent of any previously interrupted sessions for a corresponding user. In particular, the message includes session identities, such as URLs, for each previously interrupted session.

The session agent in turn presents this information to the user of the mobile network device. The user then selects one or more sessions that they are interested in resuming. Alternatively, the sessions may be selected automatically by the session agent in accordance with a pre-configured selection policy. In either case, the session agent sends a session selection message to the session manager as shown at 33. This message indicates to the session manager the session identifiers of one or more of the available sessions that the mobile user wishes to resume from the new device location.

In response to the session selection message, the session manager sends a session select acknowledgement message 34 to the session agent. This message acknowledges the session selections from the user as well as indicates that the session manager is ready to provide the necessary context data so that mobile device can resume the selected sessions. This message may optionally include amount of memory required for receiving the download of context information from the session manager. In case of HTTP, the state information is generally captured in cookies such that the amount of state information is not very large. However, in the case of proprietary applications, this information can help a device to prepare for receiving a large amount of context data.

Upon receipt of the session select acknowledgement message, the session client sends a session resume indication message at 35 to the session manager. This message is a status indicator to inform the session manager that it is ready to accept data. At this time, the session agent may revoke any previously selection that it may have indicated earlier to the session manager. For instance, the session agent may revoke a previous selection when the amount of context data exceeds the available memory space of the device.

In response to the session resume indication message, the session manager sends the session context information 36 back to the session agent. To do so, the session state data is retrieved from its local data store by the session manager. In an exemplary embodiment, the session state data is then encoded in XML format for transmission to the client device. Based on the device type and device capabilities of the target client device, the session manager may optionally adapt the session context information for the target client device. For example, the session manager may reduce the amount of content information sent to a target client device having a smaller display (e.g., a cellphone) than the client that initiated the session. The session manager may also configure other networking components that may require provisioning of QoS, bandwidth etc. to enable the same quality of service as was previously provided to the user.

After processing the session state data received from the session manager, the session agent sends a session data acknowledgement message 37 back to the session manager. This message acknowledges to the session manager that the session data has been received correctly. The session agent then uses the session state data to continue or resume the interrupted session.

The proposed session resumption protocol supports two additional message types: a session abort message and a session abort acknowledgement message. In some instances, the session manager may need to continue refreshing sessions by functioning as a proxy of the device. By sending a session abort message, a session client may indicate to the session manager that it is no longer interested in continuing a particular session. This will enable a session manager to remove the session state data from its database.

In general, the data content for each of the messages is encoded in the XML language, but can also be encoded in any other formats suitable for carrying data between two communicating entities. In addition, the proposed protocol employs separate messages for each control function to keep the protocol design simple. However, it is understood that some message may be combined to carry more than one type of control information. For example, all of the acknowledgements could be sent via a single acknowledgment message in both directions with suitably defined status codes. It is readily understood that other variations to the protocol are also within the broader aspects of the present invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A session management system for maintaining a session state with an application server, comprising:
an application client residing on a mobile network device and operable to interface with the application server;
a session manager residing on a router of a home network associated with the mobile network device, such that messages to and from the mobile network device pass through the router, the session manager operable to intercept application information being exchanged between the application client and the application server and store a session state based upon the intercepted application information; and
a session control agent residing on the mobile network device and operable to interface with the session manager to restore the session state between the application client and the application server.

2. The session management system of claim 1 further comprises another session control agent residing on a different mobile network device, wherein the another session control agent is operable to interface with the session manager to restore the session state on the different mobile network device.

3. The session management system of claim 1 wherein the session manager is further operable to capture a network access identifier for a user of the mobile network device and store the session state in conjunction with the network access identifier.

4. The session management system of claim 3 wherein the session control agent is operable to retrieve the session state from the session manager using the network access identifier of the user of the mobile network device.

5. The session management system of claim 1 wherein the application client is further defined as a Web browser and the application server is further defined as a Web server.

6. The session management system of claim 1 wherein the application client and the application server interface using Hyper Text Transfer protocol.

8. The session management system of claim 1 wherein the session control agent interfaces with the session manager to restore the session state upon attachment of mobile network device to a network.

9. The session management system of claim 1 wherein the mobile network device is attached to a network other than the home network.

10. The session management system of claim 1 wherein the session state for a given session between the application client and the application server is comprised of session context data, service context data, device context data and application context data.

11. The session management system of claim 1 wherein the session control agent communicates operating characteristics of the mobile network device to the session manager and the session manager adapts the session state based on the operating characteristics of the mobile network device.

12. The session management system of claim 1 wherein the session manager is integrated with at least one of a foreign agent or a home agent as defined by a Mobile IP protocol.

13. A method for restoring a session state for an application residing on a mobile network device, comprising:
intercepting application information being exchanged between the application and an application server at a network routing device, the network routing device disposed outside of a network domain associated with the application server;
storing a session state for the exchanges between the application and the application server based on the intercepted application information; and
subsequently transferring the session state to the application.

14. The method of claim 13 further comprises storing a session state on the network routing device and transferring the session state from the network routing device to the application residing on the mobile network device.

15. The method of claim 13 further comprises capturing a network access identifier for a user of the mobile network device and storing the session state in conjunction with the network access identifier.

16. The method of claim 15 further comprises retrieving the session state using the network access identifier of the user of the mobile network device.

17. The method of claim 13 further comprises sending a session request message from the application to the network routing device and returning to the application a list of stored session states associated with the mobile network device.

18. The method of claim 13 further comprises communicating operating characteristics of the mobile network device to the network routing device and adapting the session state based on the operating characteristics of the mobile network device.

19. The method of claim 13 wherein the session state for a given session is comprised of session context data, service context data, device context data and application context data.
